(19) United States
(12) Patent Application Publication
(10) Pub. No.: US 2004/0042349 A1
(43) Pub. Date: Mar. 4, 2004

(54) Use of a non-magnetic coating to cover parts in a watch movement

(76) Inventors: Frederic Leuba, La Chaux-de-Fonds (CH); Denis Burdet, Neuchatel (CH)

Correspondence Address: Robinson & Post, L.L.P., 12900 Preston Road, LB-41, Dallas, TX, 75230, US

(21) Appl. No.: 10/649,304

(22) Filed: Aug. 27, 2003

(30) Foreign Application Priority Data
Feb. 28, 2001 (EP) 01200752.2

(51) Int. Cl. G04B 1/00; G04C 3/00

(52) U.S. Cl. 368/204

(57) ABSTRACT

The present invention proposes to improve the yield of a micro-generator (1) used for operating a timepiece. This micro-generator operates on the basis of the phenomenon of electromagnetic induction; it is thus desirable to limit the presence of magnetic masses in proximity to said generator as much as possible. Research carried out has shown that the finish coating covering the movement-blank parts (11, 12) arranged in proximity to the micro-generator brakes the latter when it is made of a magnetic material, and in particular a ferromagnetic material. Thus, the exclusive selection of non-magnetic materials for manufacturing the movement-blank and its coating is proposed.

The present invention concerns a timepiece movement including in particular an operating unit comprising magnetised masses, said operating unit being located at the heart of said movement and thus surrounded at least partially by non-magnetic movement-blank parts coated with a finish coating.

In particular, the present invention concerns a timepiece wherein said operating unit is a micro-generator.

In the following description, “non-magnetic” material means a material, which is not ferromagnetic, which is not or is only very slightly paramagnetic, and which may have slight diamagnetism. Likewise, “in proximity to the micro-generator” means any peripheral region of the micro-generator in which the magnetic flux of the magnetised masses has a significant value.

The operating principle of such a timepiece movement is described in particular in Swiss Patent No. 597636 and European Patent No. 851322, the teaching of which is incorporated by reference in the present Application. Swiss Patent No. 597636, for example, discloses a watch movement wherein a spring drives, via a set of gears, on the one hand the hands and on the other hand, a generator generating an alternating current. The generator powers an electronic circuit comprising in particular a stabilised quartz oscillator and enabling the working of the generator and thus the working of the hands, to be adjusted. Such a watch consequently combines the advantages of a mechanical watch with the precision of a quartz watch.

However, while seeking to develop a product of this type, the Applicant observed the existence of sources of magnetic disturbance within the watch movement. The advantage of this type of timepiece increases when its energy consumption decreases, i.e. when for example the generator yield increases. With this observation as a starting point, the Applicant proved that not only ferromagnetic masses, such as movement-blank parts or steel watch parts, but also the presence of fine layers of ferromagnetic coating on non-magnetic movement-blank parts, located in proximity to the generator, exert thereon a parasitic magnetic force thereby reducing its yield.

The object of the present invention is thus to improve the aforementioned timepiece while avoiding the drawbacks described hereinbefore, in particular owing to an improvement, which is simple and inexpensive to manufacture.

The invention therefore concerns a timepiece of the type indicated hereinbefore, characterised in that said finish coating covering said movement-blank parts located in proximity to said operating unit has essentially non-magnetic properties.

According to a particular embodiment of the invention, the various movement-blank parts are coated with a nickel-based non-magnetic alloy providing efficient protection against the risk of oxidisation while guaranteeing a very proper aesthetic appearance. It should be noted that this type of alloy has excellent adherence to the surface of the movement-blank.

In another alternative embodiment, said first nickel-based layer is coated with a second metallic layer, in particular in order to modify the aesthetic appearance. One may, for example, use a gold-based alloy to give the movement-blank a golden colour, which generally results in a more luxurious level of finish for the timepiece. In such case, the nickel-based first layer also has the function of a diffusion barrier, preventing the gold from diffusing into the movement-blank material.

The invention will be explained in more detail with the aid of the following description of an example embodiment, made with reference to the annexed drawings, in which:

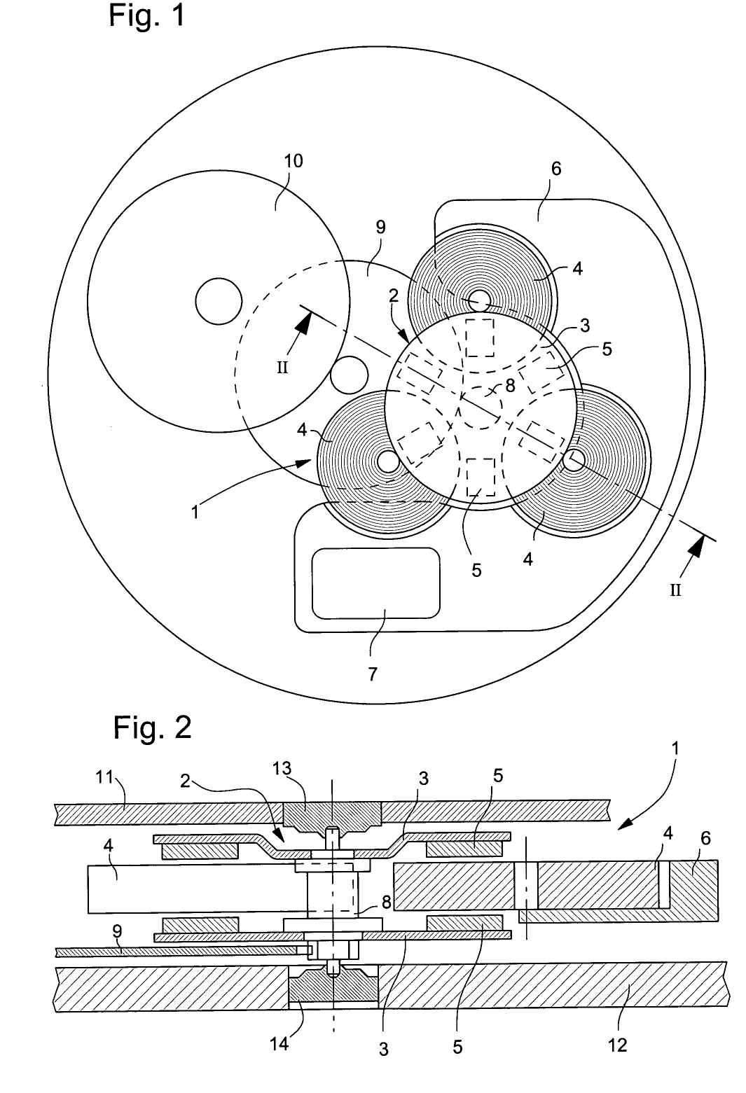

FIG. 1 is a simplified top view of the partially mounted movement of a timepiece including a generator, and

FIG. 2 is a transverse cross-section of the movement along the line II-II of FIG. 1.

FIG. 1 shows a view of generator 1 comprising a rotor 2 having two flanges 3, only one of which is shown, arranged on either side of three flat coils 4 forming the stator and offset by substantially 120 degrees in relation to each other relative to the axis of rotor 2, in a same plane orthogonal to the latter.

Six magnets 5 are fixed radially and at regular intervals on each flange 3, facing coils 4. The polarity of two consecutive magnets 5 is opposite. Moreover, the faces facing each other of the superposed magnets 5 have opposite polarities. A printed circuit board 6 acts as a support in particular for coils 4 and for an integrated circuit 7.

Integrated circuit 7, which is a low energy consumer, is powered by electric micro-generator 1—formed by the assembly of shaft 8 of rotor 2, flanges 3, magnets 5 and coils 4—driven via a kinematic connection 9 by a barrel device 10. When magnets 5 pass in proximity to coils 4 this generates a substantially sinusoidal induced voltage across the terminals of coils 4.

Brass movement-blank parts 11 and 12 appear in the cross-section along line II-II of FIG. 1 shown in FIG. 2. In particular, shaft 8 of rotor 2 is mounted so as to pivot in two jewels 13, 14, one of which being driven into a gear train-bar 11 and the other into movement plate 12. FIG. 2 clearly shows that, because of their immediate proximity to magnets 5, said movement-blank parts 11, 12 are partially exposed to the magnetic fields of said magnets.

The Applicant has proved during his research that the fact of using a conventional magnetic material to make the finish coating for the movement-blank has a significant influence on the micro-generator yield. Astonishingly, the exclusive use of non-magnetic materials for the coating causes a substantial decrease in magnetic disturbance, the magnetic coupling between magnetised masses 5 and coils 4 and thus the yield of micro-generator 1 being thereby increased.

The watch movement according to the invention thus includes at least movement-blank parts 11, 12 made of brass or any other suitable material having non-magnetic properties. Moreover, in accordance with the invention, the movement-blank is coated with a protective metal coating against oxidisation. For the aforecited reasons, this metal coating is also made of a material, which does not have magnetic properties, such as a non-magnetic alloy of nickel with phosphorus or tin. When the movement is intended to be mounted in a timepiece of high added value, a rhodium-based non-magnetic alloy can be used to make the coating of said movement-blank parts 11 and 12.

In an alternative embodiment, it may be desirable to make a coating comprising at least two layers of different materials. Indeed, if one wishes to manufacture a movement with a golden finish on the movement-blank, a first treatment should be applied to said movement-blank parts 11, 12 in order to coat them with a protective sub-layer, generally made of nickel. A first protective layer against oxidisation is thus obtained which also fulfils the function of a diffusion barrier, preventing the gold from diffusing into the movement-blank material.

Surprisingly, research has shown that even when the visible layer is made of gold or rhodium which are non-ferromagnetic materials, the single magnetic nickel-based sub-layer decreases the generator yield and thus the power reserve available for the timepiece. This is why this fine sub-layer is formed here of a non-magnetic alloy, preferably nickel-based, in accordance with the invention.

A nickel-based alloy including phosphorus may be used for this purpose, since for certain of its composition values, the alloy does not have magnetic properties. One might use other metals to replace the nickel, such as palladium for example certain alloys of which also have non-magnetic properties. Since the making of the finish coating itself does not constitute the heart of the invention, it will not be developed in more detail in the present Application. Those skilled in the art may refer in particular to U.S. Pat. No. 6,099,624 disclosing examples of alloys used in the manufacture of metallic protective coatings, also used for aesthetic purposes.

Multiple applications may be imagined, in the horological field, for the selection of non-magnetic materials to cover the movement-blank in accordance with the invention. Indeed, the use of such materials was described in the case of a timepiece operating with a micro-generator, but such materials may also be used in any other type of timepiece with sensitivity to magnetic disturbance. The invention may be implemented in particular in a timepiece wherein the operating unit is a compass, or in any other type of timepiece implementing means interacting with an external magnetic field, in particular for the purpose of detecting it.

1. Timepiece movement including in particular a micro-generator (1) including magnetised masses (5), said micro-generator (1) being surrounded at least partially by non-magnetic movement-blank parts (11, 12) coated with a finish coating, characterised in that the finish coating covering said movement-blank parts (11, 12) located in proximity to said micro-generator (1) has essentially non-magnetic properties.

2. Timepiece movement according to claim 1, characterised in that said coating includes at least two metallic layers of which at least the layer which is directly in contact with said movement-blank parts (11, 12) contains nickel as a non-magnetic alloy constituent.

3. Timepiece movement according to claim 1 or 2, characterised in that said micro-generator (1) includes a rotor (2) including two flanges (3) each substantially disc-shaped and each carrying, on its face opposite the other flange, an even number of magnetised masses (5), said micro-generator further including an electronic module (6) including at least a stator coil (4) partially inserted between the two flanges (3) and in that said micro-generator is at least partially located in a volume delimited by the orthogonal projections of said non-magnetic movement-blank parts (11, 12).

4. Timepiece movement including in particular an operating unit (1) including magnetised masses (5) and allowing the presence of an external magnetic field to be detected, said operating unit (1) being surrounded at least partially by non-magnetic movement-blank parts (11, 12) coated with a finish coating, characterised in that the finish coating covering said movement-blank parts (11, 12) located in proximity to said operating unit (1) has essentially non-magnetic properties.

5. Timepiece movement according to claim 4, characterised in that said operating unit has the function of a compass.
